(19) United States
(12) Patent Application Publication
(10) Pub. No.: US 2005/0170318 A1
(43) Pub. Date: Aug. 4, 2005

(54) Stunt card and method for performing card stunts

(76) Inventor: Paul Yeomans, Lafayette, CA (US)

Correspondence Address: BEESON SKINNER BEVERLY LLP, ONE KAISER PLAZA, SUITE 750, OAKLAND, CA, 94612, US

(21) Appl. No.: 11/046,483

(22) Filed: Jan. 28, 2005

Related U.S. Application Data
(60) Provisional application No. 60/540,771, filed on Jan. 30, 2004.

(51) Int. Cl. G09B 11/00

(52) U.S. Cl. 434/81

(57) ABSTRACT

A stunt card for performing card stunts by participant members of a crowd in common attendance at an event at a venue, preferably one having a seating arrangement such as a sporting event in a sports stadium, comprises a planar medium, foldable between unfolded and folded configurations to form a stunt color panel, a commemorative panel, and a theme panel. In a folded configuration the stunt card preferably includes two visible sides each obverse to the other; one side forming a stunt color panel, the other forming a theme panel. A selected color is depicted on substantially all of the stunt color panel and a thematic design is depicted on the theme panel. The design on the theme panel is preferably related to the event at which the crowd is in attendance, but may reflect any theme that is commonly meaningful to the crowd. The folded stunt card has sufficient rigidity to enable it be flipped over quickly from the theme panel to the stunt color panel and still substantially retain its planar shape. Opening the stunt card to the unfolded configuration exposes the commemorative panel. The commemorative panel depicts printed matter calculated to motivate retention of the stunt card.

This application claims the benefit of U.S. Provisional Application No. 60/540,771, filed Jan. 30, 2004.

### BACKGROUND OF THE INVENTION

This invention relates to stunt cards used to perform card stunts by the coordinated action of members of a crowd in attendance at an event. The invention also is directed to a method for performing such card stunts using the stunt cards.

Card stunts involving the large scale coordinated display of colored cards to form a pattern, a word or phrase, or an image have become a popular and enjoyable component of sports events and other large gatherings. Generally, stunt cards used to perform such card stunts are colored on one or both sides. The colored side is displayed outwards according to verbal instructions. Once the card stunt is performed, the stunt cards are discarded. A significant promotional opportunity is lost with each discarded stunt card.

### SUMMARY OF THE INVENTION

A stunt card for performing card stunts by participant members of a crowd in common attendance at an event at a venue, preferably one having a seating arrangement such as a sporting event in a sports stadium, comprises a planar medium, foldable between unfolded and folded configurations to form a stunt color panel, a commemorative panel, and a theme panel.

In a first folded configuration the stunt card preferably includes two visible sides each obverse to the other; one side forming a stunt color panel, the other forming a theme panel. A selected color is depicted on substantially all of the stunt color panel and a thematic design is depicted on the theme panel. The design on the theme panel is preferably related to the event at which the crowd is in attendance, but may reflect any theme that is commonly meaningful to the crowd. For example, the theme panel could depict a national flag. The folded stunt card has sufficient rigidity to enable it be flipped over quickly from the theme panel to the stunt color panel and still substantially retain its planar shape.

Instructions displayed on an instruction panel included as part of the stunt color panel provide directions on how to perform the card stunt. Each participant is directed to hold up the theme panel upon perception of a first cue. For example, the instructions may prompt the participants to hold up the theme panel as the national anthem begins. Since the instructions are printed on the stunt color panel, they remain visible to the participant who is holding up the obverse theme panel for viewing by the crowd. The instructions next provide that, upon perception of a second cue, the stunt card is to be flipped over to display the stunt color panel. Although at reading distance the instructions on the stunt color panel appear clearly against the color depicted on the stunt color panel, since the pattern or design formed by the card stunt results from the display of all the stunt card panels on a large scale, the instructions are largely imperceptible from a distance and do not interfere with visual recognition of the card stunt pattern.

The cues used to prompt manipulation of the stunt cards by crowd participants take useful advantage of the event at which the card stunt is to be performed by identifying easily discernable and predictable occurrences drawn from the event agenda. Each selected occurrence signals the participants to perform a step in the sequence of card stunt steps set forth on the instructions. Performance of the card stunt does not require a set of cues developed exclusively for the card stunt. Rather, the use of external cues drawn from the event at which the crowd is in attendance allows the card stunt to be integrated into and enhance the event.

Opening the stunt card to the unfolded configuration exposes the commemorative panel. In a folded configuration the commemorative panel is hidden from view and does not interfere with the rapid manipulation of the stunt card necessary to successfully perform the card stunt. The commemorative panel depicts printed matter calculated to motivate crowd members to retain the stunt card. The commemorative panel preferably opens to the size of a typical poster and is suitable for mounting. Preferably the printed matter depicted on the commemorative panel is commemorative of the event being attended by the crowd and may include photographs, logos, and other interesting information related to the event. The commemorative panel may also display advertisements for one or more sponsors of the card stunt. Accordingly, the sponsor or sponsors will benefit from exposure of their names or trademarks not only during the card stunt but after performance of the card stunt to the extent the stunt cards are retained, especially if for display of the commemorative panel.

In the preferred embodiment, the stunt card is rectangular, which when unfolded, has the dimensions of a standard poster, e.g., 14″×22″, and may be folded twice along two fold lines. Folding the commemorative panel back on itself along one of the fold lines reconfigures the stunt card into a first folded configuration in which the stunt color panel and the theme panel are exposed on obverse sides. Folding along a second fold line closes the theme panel leaving two halves of the stunt color panel exposed on obverse sides, one of which defines an instructions panel containing the instructions for performing the card stunt.

In preparation for the card stunt, a design is created based on the seating pattern of the venue. Any number of colors can be used to create the design. The design contemplates that each participant in the crowd will display one color of a set of selected colors on the stunt cards distributed throughout the crowd based on the seating pattern. The design therefore reflects and is constrained by the seating pattern at the venue. However, the coordinated display of a stunt card design is possible anywhere that the relative positions of the members of a crowd of persons can be predicted and controlled. Therefore, a card stunt such as described herein can be performed at, not only sporting events, but conventions, concerts, political gatherings, religious meetings, fundraising events, and even parades.

### BRIEF DESCRIPTION OF THE ILLUSTRATIONS

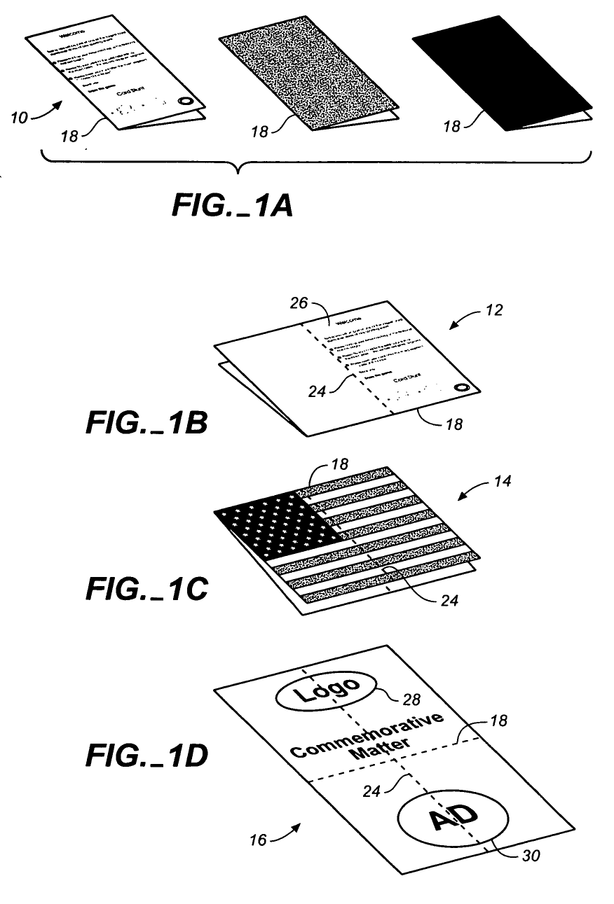

FIG. 1A is a series of perspective views of three stunt cards according to the invention, each folded along a first fold line to expose the stunt color panel of that stunt card. Each stunt color panel displays a different color.

FIG. 1B is a perspective view of a stunt card according to the invention showing the stunt color panel, instructions for performing a card stunt on an instructions panel on the right side of the stunt color panel, and a dashed line to indicate a second fold line.

FIG. 1C is a perspective view of the stunt card of FIG. 1B showing the theme panel on the obverse side, the dashed line indicating an extension of the second fold line shown in FIG. 1B.

FIG. 1D is a perspective view of the stunt card of FIGS. 1B and 1C unfolded to show the commemorative panel, dashed lines indicating first and second fold lines.

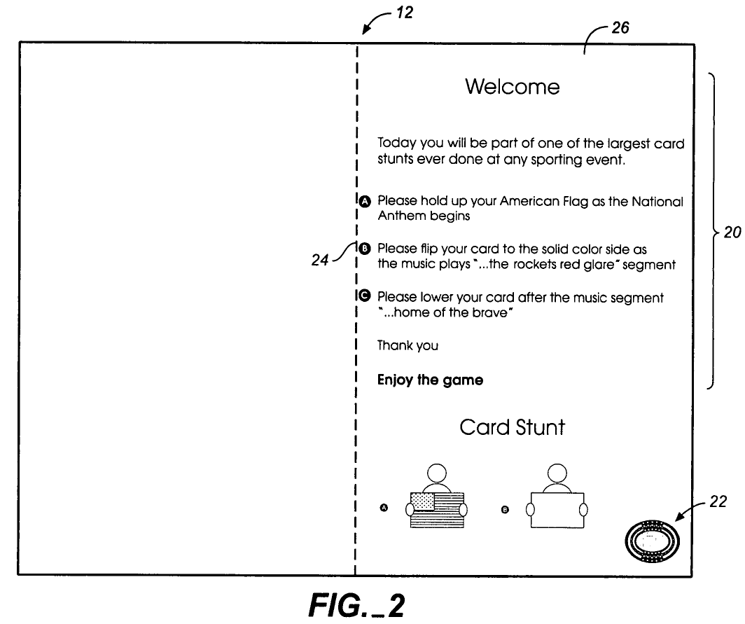

FIG. 2 is a plan view of the stunt color panel shown in FIG. 1B identifying the card as a being for a “Card Stunt” and showing instructions and a logo of a stunt card design in the lower right corner.

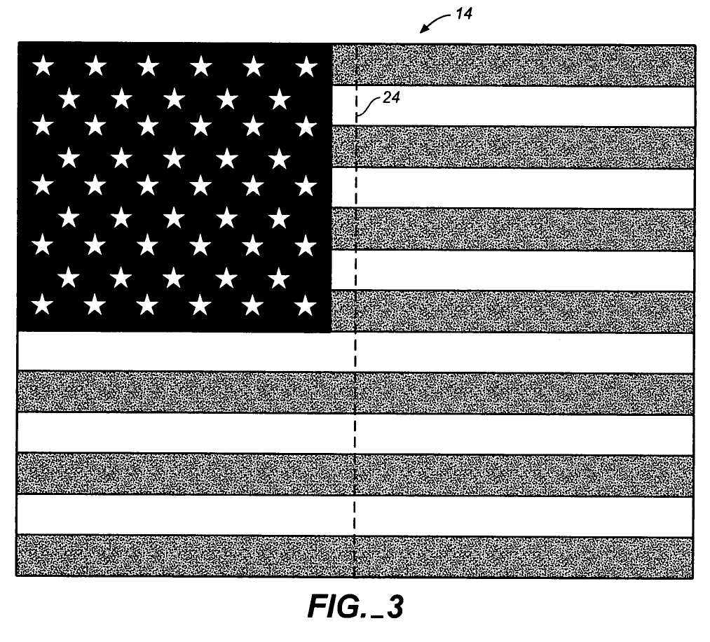

FIG. 3 is a plan view of the theme panel shown in FIG. 1C.

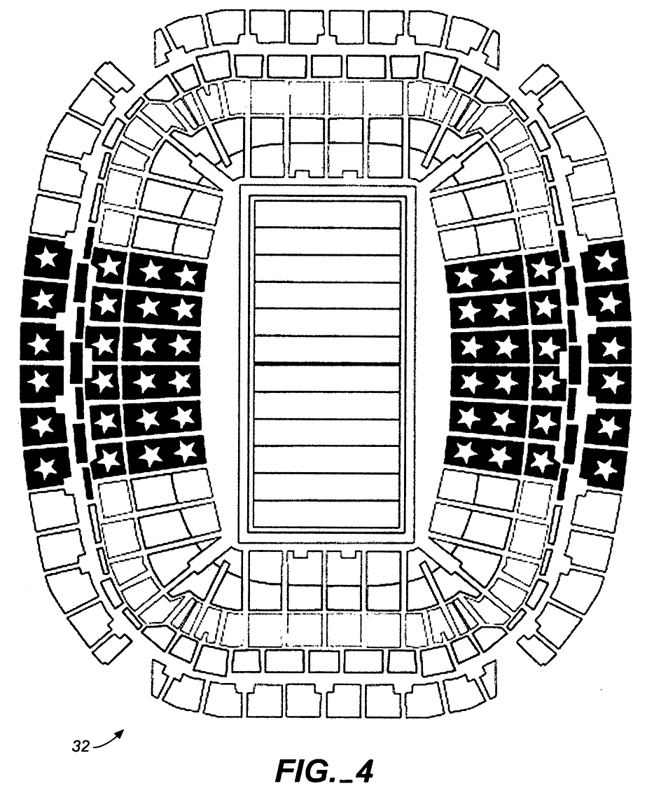

FIG. 4 is a plan view of a design which may be depicted by performing a card stunt using the colors on the stunt card color panels shown in FIG. 1A.

### DETAILED DESCRIPTION OF THE ILLUSTRATED EMBODIMENT

A stunt card 10 according to the invention, with reference to FIGS. 1B-1D, comprises a stunt color panel 12 (FIG. 1B), a theme panel 14 (FIG. 1C), and a commemorative panel 16 (FIG. 1D). The stunt card 10 is preferably constructed of card stock, but can be constructed of any planar medium such as vinyl or another plastic as long as its surfaces are capable of displaying printed matter and can be folded as described below. Each of the stunt cards seen in FIGS. 1B-1D are folded along a first fold line 18 into a first folded configuration in which the stunt color panel and the theme panel are on obverse exposed sides of the stunt card. A selected color is printed on the entire surface of the stunt color panel except for a set of instructions 20 and a logo 22 of the card stunt design as shown in FIG. 2. FIGS. 1B and 1C depict a second fold line 24 about which the stunt card may be folded into a second folded configuration (not illustrated) to a size more manageable for hand-carrying or for slipping in a presentation packet. Generally the theme panel 14 is folded back upon itself to define an instructions panel 26 on one half of the stunt color panel. Alternative embodiments may include rearrangements of the stunt color, theme, commemorative, and instruction panels, incorporate different fold patterns including folding configurations to form three dimensional objects such as paper hats or paper airplanes, or which pop up into objects or shapes upon being unfolded. In further embodiments, the stunt card may be perforated to form a shape or to allow viewing through the perforations.

Unfolding the stunt card exposes the commemorative panel 16 as seen in FIG. 1D. The commemorative panel preferably unfolds to approximately the size of a standard poster so that it is suitable for framing or other display. On the commemorative panel is displayed matter commemorative of the event at which the card stunt is being performed. This matter may include a background design, an event logo 28, photographs, depictions of prominent persons, maps, trivia, stories, or any information reasonably calculated to motivate retention of the card. Accordingly, for example, a stunt card for a card stunt intended to be performed at the Rose Bowl may include the Rose Bowl Game logo, historical pictures from previous Rose Bowl games and from previous Rose Parades, and guest shots of personalities scheduled to appear in the current Rose Bowl or Rose Parade. It will be readily understood, however, that alternate embodiments of a stunt card according to the invention may incorporate the commemorative panel or at least discrete commemorative matter into the stunt color or theme panels.

An alternate embodiment of a stunt card according to the invention is foldable along first and second fold lines similar to those depicted in FIGS. 1A-1D. In a fully unfolded configuration, one side comprises a stunt color panel and the obverse side displays a theme panel, effectively doubling the area for display of color on the stunt color panel and for display of the thematic design on the theme panel as compared to the panel configuration in the preferred embodiment described above. The alternative stunt card is foldable into a double folded configuration by folding it twice along the first and second fold lines. In the double folded configuration, two quarters of the stunt color panel are exposed on obverse sides, one of which defines an instructions panel containing the stunt card instructions and the card stunt design logo, and on the other of which is displayed commemorative matter. This embodiment is particularly useful where promotional matter may be restricted, or if the commemorative matter may be unusually desirable such as in the case of a card stunt for performance at the Super Bowl.

In addition to commemorative matter, the commemorative panel 16 may include one or more advertisements 30 promoting a sponsor or sponsors of the card stunt. See FIG. 1D. Incorporation of the advertising matter on the commemorative panel increases the likelihood that a sponsor's name will be retained along with the commemorative matter. A sponsor therefore enjoys a substantial promotional benefit, not just during the event from exposure to the crowd participating in the card stunt, but afterwards from post-event reinforcement.

Referring now to FIG. 2, one side of the stunt color panel 12 defines an instructions panel 26 containing textual and graphical instructions 20 directing performance of the card stunt and a logo 22 of the design to be formed by performance of the card stunt. The words “Card Stunt” indicate use of the stunt card for participation in a card stunt. The instructions first direct the participant to hold up the theme panel upon perception of a first cue. According to the invention, the cue is derived from an occurrence at the event which is external to the card stunt. The occurrences used to cue steps in the process of performing the card stunt are generally drawn from the event program, but it will be understood that any external occurrence could be used which is capable of being unambiguously perceived by the crowd. In the illustrated embodiment, for example, the instruction requests that the participant “hold up your American Flag as the National Anthem begins.” A first graphic at (A) in the lower portion of the card, reinforces the instruction. The theme panel could depict anything thematically related to the event, such as the Rose Bowl Game Logo at the Rose Bowl, or any image having a generally understood meaning such as the national flag, as seen in FIG. 3. As the theme panel is being held up, the instructions conveniently are disposed in front of the participant where the next step can be studied. The participant is next directed to flip the stunt card over to the stunt color panel upon perception of a second cue. In the illustrated embodiment, for example, the instruction requests that the participant “flip your card to the solid color side as the music plays ‘ . . . the rocket's red glare’” segment. A second graphic at (B) in the lower portion of the card reinforces this instruction. A card stunt design is dramatically formed at this step by the crowd's coordinated mutual display of the stunt color panels of all the stunt cards in the venue. See FIG. 4. Although the instructions are clearly and obviously visible on each stunt card at reading distance, since the card stunt pattern is formed from viewing the accumulated display of all the stunt cards in the venue on a large scale, e.g., from across a sports stadium or from above, the instructions have a negligible impact on formation and visual recognition of the design. The final instruction directs the participant to lower the stunt card after a third cue, in the illustrated example, “after the music segment ‘ . . . home of the brave.’”

A card stunt design according to the invention is directly related to the seating pattern of the venue. Preferably a pattern is formed from display at each seat location of the solid color on a stunt card assigned to that seat. Referring to FIG. 4, the patriotic stars and stripes design 32 shown is formed from stunt color panels colored red, white and blue held up at the second cue described above. The design formed is therefore unique to, but dictated in part by, the venue. It will be appreciated that alternate embodiments of the card stunt may display an image composed of an unlimited number of colors. An alternative method for performing a card stunt is to divide a large image into sections each of which is printed on the stunt color panel of a set of stunt cards similar to how a jigsaw puzzle is created. A further embodiment is an electronic card stunt in which an image is produced by a computer and overlain onto a crowd image. In each case, however, the stunt card includes the commemorative panel.

Preparation for performance of a card stunt as described begins with obtaining the seat pattern for the venue at which the performance will take place. A design generally is created by assigning a color to each seat in the venue. By treating each seat as a point of color, a large scale design is developed. Once a design has been settled on, arrangements are made to physically provide a stunt card to each seat which will be used as a color point in the design, the stunt card for each particular seat having a stunt color panel displaying the color assigned to that seat. This method has the distinct advantage that the participants in the card stunt all follow the same instructions rather than forcing blocks of participants to perform different steps in the card stunt at different times.

There have been thus described certain preferred embodiments of a stunt card and a method of performing card stunts. While preferred embodiments have been described and disclosed, it will be recognized by those with skill in the art that modifications are within the true scope and spirit of the invention. The appended claims are intended to cover all such modifications.

1. A stunt card for use in staging a card stunt, the stunt card comprising:
a stunt color panel, a selected color shown on substantially all of said stunt color panel,
a commemorative panel including promotional matter, and
a folded configuration for displaying only said stunt color panel.

2. The stunt card of claim 1 wherein:
said stunt color panel has instructions directing how to perform the card stunt.

3. The stunt card of claim 2 wherein:
said instructions direct display of said stunt color panel upon the occurrence of a detectable cue.

4. The stunt card of claim 3 wherein:
said cue is commonly detectable by each of a plurality of individuals participating in a card stunt, such that said plurality of individuals simultaneously displays a plurality of said stunt color panels to form a card stunt design.

5. The stunt card of claim 3 wherein:
said cue is independent of the card stunt.

6. The stunt card of claim 2 further comprising:
a theme panel having a thematic design,
said instructions include a first instruction directing the display of said theme panel upon the occurrence of a first detectable cue, and a second instruction directing the display of said stunt color panel upon the occurrence of a second detectable cue.

7. The stunt card of claim 6 wherein:
said first cue is commonly detectable by each of a plurality of individuals participating in a card stunt, such that said plurality of individuals simultaneously displays a plurality of said stunt color panels to form a card stunt design.

8. The stunt card of claim 6 wherein:
said stunt color panel includes a logo depicting a stunt card design formed upon performance of the card stunt.

9. The stunt card of claim 6 wherein:
said thematic design is a depiction of a national flag.

10. The stunt card of claim 1 wherein:
said commemorative panel is approximately the size of a typical poster.

11. The stunt card of claim 1 further comprising:
an unfolded configuration for displaying said commemorative panel.

12. The stunt card of claim 1 wherein:
said promotional matter is commemorative of an event.

13. The stunt card of claim 12 wherein:
said promotional matter is commemorative of an event at which the card stunt is to be performed.

14. The stunt card of claim 1 wherein:
said promotional matter identifies a sponsor.

15. The stunt card of claim 1 further comprising:
a theme panel, a thematic design depicted on said theme panel,
said theme panel obversely disposed to said stunt color panel in said folded configuration.

16. The stunt card of claim 15 wherein:
said thematic design is a depiction of a national flag.

17. A stunt card for use in staging a card stunt, the stunt card comprising:
a stunt color panel, a selected color displayed on substantially all of said stunt color panel,
a commemorative panel including promotional matter,
a theme panel, a thematic design depicted on said theme panel,
a folded configuration for displaying only said stunt color panel, said theme panel obversely disposed to said stunt color panel in said folded configuration.

18. A stunt card for use in staging a card stunt, the stunt card comprising:
a stunt color panel, a selected color displayed on substantially all of said stunt color panel, said stunt color panel having instructions directing the display of said stunt color panel upon the occurrence of a cue commonly detectable by each of a plurality of individuals participating in the card stunt,
a commemorative panel including promotional matter,
a theme panel having a thematic design, and
a folded configuration for displaying only said stunt color panel, said theme panel obversely disposed to said stunt color panel in said folded configuration.

19. A stunt card for use in staging a card stunt, the stunt card comprising:
a stunt color panel, a selected color displayed on substantially all of said stunt color panel, and
a commemorative panel including promotional matter,
a theme panel depicting a thematic design,
a folded configuration for displaying only said stunt color panel, said theme panel obversely disposed to said stunt color panel in said folded configuration.

20. A card stunt system comprising:
a plurality of sets of stunt cards, each said stunt card in each said set having a stunt color panel, a selected one of a plurality of colors shown on substantially all of said stunt color panel of each stunt card of each of said plurality of sets of stunt cards, a commemorative panel including promotional matter, a first fold configuration for displaying only said stunt color panel, and a second fold configuration for displaying said commemorative panel,
a recognizable card stunt design formed upon simultaneous display of all of said stunt color panels of all of said stunt cards of all of said plurality of sets of stunt cards.

21. The card stunt system of claim 20 for use in performing a card stunt in a venue having a plurality of seats forming a seating configuration, wherein:
each of said stunt color panels of said stunt cards is displayed from one of the seats of the seating configuration.

22. A method of performing a card stunt at a venue having a plurality of seats forming a seating configuration, the method comprising:
creating a card stunt design reflecting said seating configuration,
assigning a selected one of a plurality of colors to each of the seats in the venue,
distributing to each of the seats a stunt card having a stunt color panel, said selected color shown on substantially all of said stunt color panel,
directing the display of a theme panel having a thematic design upon the occurrence of a first detectable cue,
directing the display of said stunt color panel upon the occurrence of a second detectable cue with instructions viewable during said display of said theme panel, said stunt color panel obversely disposed to said theme panel in a first fold configuration of said stunt card,
promoting retention of said stunt card by providing a commemorative panel viewable in a second fold configuration, said commemorative panel including matter commemorating an event at which the card stunt is to be performed, said commemorative panel further including matter promoting at least one sponsor of the card stunt.

23. The method of performing a card stunt of claim 22 further comprising:
directing termination of said display of said stunt color panel upon the occurrence of a third detectable cue.
